(19) United States
(12) Patent Application Publication
(10) Pub. No.: US 2014/0068321 A1
(43) Pub. Date: Mar. 6, 2014

(54) MEMORY DEVICE AND INTEGRATED CIRCUIT

(71) Applicant: SK HYNIX INC., Gyeonggi-do (KR)

(72) Inventors: Yeon-Uk KIM, Gyeonggi-do (KR); Hee-Joon LIM, Gyeonggi-do (KR); Jeong-Tae HWANG, Gyeonggi-do (KR)

(73) Assignee: SK HYNIX INC., Gyeonggi-do (KR)

(21) Appl. No.: 13/719,519

(22) Filed: Dec. 19, 2012

(30) Foreign Application Priority Data
Aug. 31, 2012 (KR) 10-2012-0096586

(51) Int. Cl. G06F 11/20

(52) U.S. Cl. CPC G06F 11/2094
USPC 714/6.3

(57) ABSTRACT

A memory device includes a nonvolatile memory, operated by using a plurality of voltages and configured to output stored repair information in response to a boot-up signal, a plurality of registers configured to store the repair information output from the nonvolatile memory, a plurality of memory banks configured to replace a normal cell with a redundancy cell using the repair information stored in registers corresponding to the plurality of memory banks among the plurality of registers, and a boot-up control circuit configured to activate the boot-up signal at a time of stabilization of the plurality of voltages.

### CROSS-REFERENCE TO RELATED APPLICATIONS

The present application claims priority of Korean Patent Application No. 10-2012-0096586, filed on Aug. 31, 2012, which is incorporated herein by reference in its entirety.

### BACKGROUND

1. Field

Exemplary embodiments of the present invention relate to an integrated circuit and a memory device, and more particularly, to a technology of determining a time point of a boot-up operation in which data is transmitted from a nonvolatile memory to registers.

2. Description of the Related Art

FIG. 1 is a diagram for explaining a repair operation in a conventional memory device.

Referring to FIG. 1, a memory device includes a cell array 110 including a plurality of memory cells, a row circuit 120 for activating a word line selected by a row address R_ADD, and a column circuit 130 for accessing (reading or writing) data of a bit line selected by a column address C_ADD.

A row fuse circuit 140 stores a row address, which corresponds to a failed memory cell in the cell array 110, as a repair row address REPAIR_R_ADD. A row comparison unit 150 compares the repair row address REPAIR _R_ADD stored in the row fuse circuit 140 with the row address R_ADD input from an exterior of the memory device. When the repair row address REPAIR_R_ADD coincides with the row address R_ADD, the row comparison unit 150 controls the row circuit 120 to activate a redundancy word line instead of a word line designated by the row address R_ADD.

A column fuse circuit 160 stores a column address, which corresponds to a failed memory cell in the cell array 110, as a repair column address REPAIR_C_ADD. A column comparison unit 170 compares the repair column address REPAIR_C_ADD stored in the column fuse circuit 160 with the column address C_ADD input from an exterior of the memory device. When the repair column address REPAIR_C_ADD coincides with the column address C_ADD, the column comparison unit 170 controls the column circuit 130 to access a redundancy bit line instead of a bit line designated by the column address C_ADD.

The conventional fuse circuits 140 and 160 mainly use a laser fuse. The laser fuse stores ‘high’ or ‘low’ level data according to whether a fuse has been cut. Programming of the laser fuse is possible in a wafer state, but may not be possible after a wafer is mounted in a package. Furthermore, it may not be possible to design the laser fuse to have a small area due to a limitation of a pitch.

In order to solve such concerns, as disclosed in U.S. Pat. Nos. 6,904,751, 6,777,757, 6,667,902, 7,173,851, and 7,269,047, one of nonvolatile memories such as an e-fuse array circuit, a NAND flash memory, a NOR flash memory, an erasable programmable read only memory (EPROM) an electrically erasable programmable read only memory (EEPROM), a ferroelectric RAM (FRAM), or a magnetoresistive RAM (MRAM) is mounted in a memory device, and repair information is stored and used in the nonvolatile memory,

FIG. 2 is a diagram illustrating a state in which a nonvolatile memory is used in order to store repair information in a memory device.

Referring to FIG. 2, a memory device includes a plurality of memory banks BK0 to BK3, registers 210_0 to 210_3 provided to the respective memory banks BK0 to BK3 to store repair information, and a nonvolatile memory 201.

The nonvolatile memory 201 replaces the fuse circuits 140 and 160. The nonvolatile memory 201 stores repair information corresponding to all the banks BK0 to BK3, that is, repair addresses. The nonvolatile memory may include one of an e-fuse array circuit, a NAND flash memory, a NOR flash memory, an EPROM, an EEPROM, a FRAM, and a MRAM.

The registers 210_0 to 210_3 provided to the respective memory banks BK0 to BK3 store repair information of the memory banks corresponding to the registers 210_0 to 210_3. The register 210_0 stores repair information of the memory bank BK0, and the register 210_2 stores repair information of the memory bank BK2. Each of the registers 210_0 to 210_3 includes a latch circuit and stores the repair information only while power is being supplied. The repair information to be stored in the registers 210_0 to 210_3 is received from the nonvolatile memory 201. The nonvolatile memory 201 transmits stored repair information to the registers 210_0 to 210_3 from the activation time point of a boot-up signal BOOTEN.

Since the nonvolatile memory 201 is prepared in the form of an array, a predetermined time is required in order to call data stored therein. That is, since immediate data call is not possible, it may be difficult to perform a repair operation directly using the data stored in the nonvolatile memory 201. Therefore, the repair information stored in the nonvolatile memory 201 is transmitted to the registers 210_0 to 210_3, and the data stored in the registers 210_0 to 210_3 is used in the repair operation of the memory banks BK0 to BK3. A process, in which the repair information stored in the nonvolatile memory 201 is transmitted to the registers 210_0 to 210_3, will be called boot-up, wherein only when the boot-up operation is completed, it is possible for the memory device to repair a failed cell and perform a normal operation.

As described above, in the memory device for storing the repair information using the nonvolatile memory 201, it is necessary to perform the boot-up operation before a normal operation, for example, read and write operations. In the conventional methods, the boot-up operation is started in response to the activation of an initialization signal, for example, a reset signal, applied to the memory device. However, the initialization signal may not be used according to an application to which the memory device is applied, or a period in which the boot-up operation is possible, may exist before the activation time point of the initialization signal. In this regard, it may be necessary to provide a technology of controlling the boot-up operation to be started at the most early time.

### SUMMARY

Exemplary embodiments of the present invention are directed to find the most early time, at which a boot-up operation is possible, in a memory device or an integrated circuit other than the memory device, and to complete the boot-up operation at the most early time.

In accordance with an embodiment of the present invention, a memory device includes a nonvolatile memory operated by using a plurality of voltages, and configured to output stored repair information in response to a boot-up signal, a plurality of registers configured to store the repair information output from the nonvolatile memory, a plurality of memory banks configured to replace a normal cell with a redundancy cell using the repair information stored in registers corresponding to the plurality of memory banks among the plurality of registers, and a boot-up control circuit configured to activate the boot-up signal at a time of stabilization of the plurality of voltages.

In accordance with another embodiment of the present invention, an integrated circuit includes a nonvolatile memory operated by using a plurality of voltages and configured to output stored data in response to a boot-up signal, a plurality of registers configured to store the data output from the nonvolatile memory, a plurality of internal circuits configured to operate using the data stored in registers corresponding to the plurality of internal circuits among the plurality of registers, and a boot-up control circuit configured to activate the boot-up signal at a time of stabilization of the plurality of voltages.

According to the present invention, whether voltages used in a nonvolatile memory have been stabilized is checked, and a boot-up operation is started immediately after the voltages are stabilized. Consequently, it may be possible to start the boot-up operation at the most early time point at which a stable boot-up operation is performed.

### BRIEF DESCRIPTION OF THE DRAWINGS

FIG. 1 is a diagram for explaining a repair operation in a conventional memory device.

FIG. 2 is a diagram illustrating a conventional nonvolatile memory used in storing repair information.

FIG. 3 is a configuration diagram of a memory device in accordance with an embodiment of the present invention.

FIG. 4 is a diagram of a boot-up control circuit shown in FIG. 3 in accordance with an embodiment.

FIG. 5 is a diagram of a damp unit shown in FIG. 4 in accordance with an embodiment.

FIG. 6 is a diagram of a voltage detection unit shown in FIG. 4 in accordance with an embodiment.

FIG. 7 is a diagram of a voltage detection unit shown FIG. 4 in accordance with an embodiment.

FIG. 8 is a diagram of a voltage detection unit shown in FIG. 4 in accordance with an embodiment.

FIG. 9 is a diagram of a boot-up control circuit shown in FIG. 3 in accordance with another embodiment.

FIG. 10 is a diagram of an integrated circuit in accordance with an embodiment of the present invention.

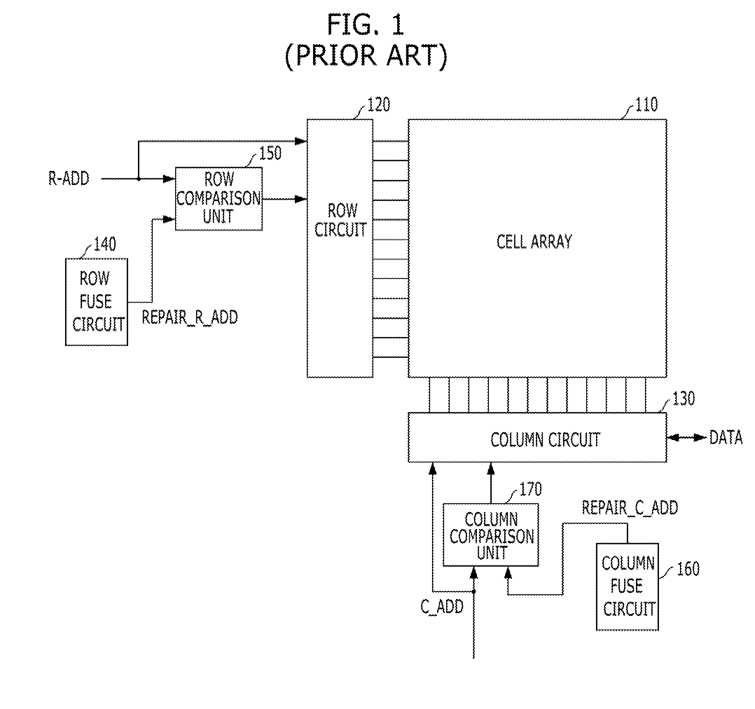

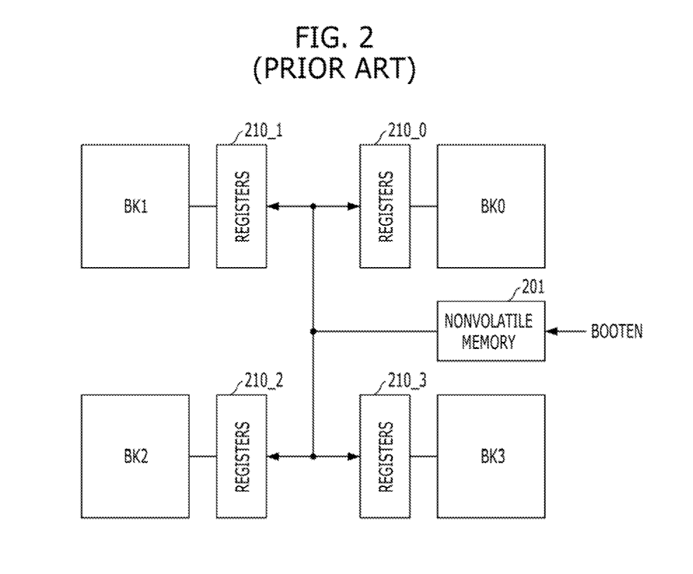

### DETAILED DESCRIPTION

Exemplary embodiments of the present invention will be described below in more detail with reference to the accompanying drawings. The presents invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout he disclosure, like reference numerals refer to like parts throughout the various figures and embodiments of the present invention.

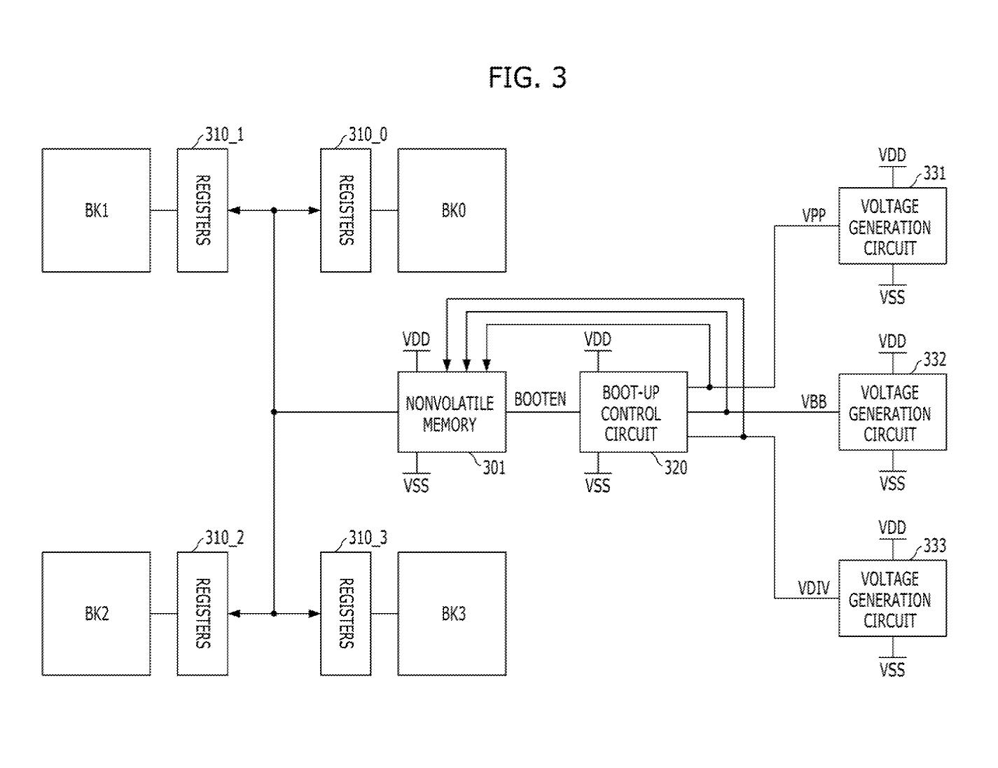

FIG. 3 is a diagram of a memory device in accordance with an embodiment of the present invention.

Referring to FIG. 3, the memory device includes a nonvolatile memory 301, a plurality of registers 310_0 to 310_3, a plurality of memory banks BK0 to BK3 a boot-up control circuit 320, and voltage generation circuits 331 to 333.

Voltages input from an exterior of the memory device include a power supply voltage VDD having a level of about 1.2 V to about 2.0 V and a ground voltage VSS. However, for the operation of the nonvolatile memory 301, voltages of various levels are required. For example, when the nonvolatile memory 301 is an e-fuse array circuit, it may be necessary to ensure a level difference of about 6 V between the highest voltage and the lowest voltage in order to program an e-fuse. When the nonvolatile memory 301 is a flash memory, it is necessary to ensure a level difference of about 15 V to about 20 V between the highest voltage and the lowest voltage for program operation and read operation. Accordingly, the nonvolatile memory 301 also uses voltages VPP, VBB, and VDIV generated in the voltage generation circuits 331 to 333 in the memory device, in addition to the voltages VDD and VSS input from an exterior of the memory device.

The voltage generation circuits 331 to 333 generate the voltages VPP, VBB, and VDIV, which are to be used in the nonvolatile memory 301, using the power supply voltage VDD and the ground voltage VSS input from an exterior of the memory device. The voltage generation circuit 331 pumps the power supply voltage VDD and generates the high voltage VPP having a level higher than that of the power supply voltage VDD. The voltage generation circuit 332 pumps the ground voltage VSS and generates the negative voltage VBB having a level lower than that of the ground voltage VSS. Furthermore, the voltage generation circuit 333 generates the division voltage VDIV having a level between the power supply voltage VDD and the ground voltage VSS through voltage division using the power supply voltage VDD and the ground voltage VSS. In the embodiment, the nonvolatile memory 301 uses the three voltages VPP, VBB, and VDIV internally generated, in addition to the voltages VDD and VSS input from an exterior of the memory device. However, the number and type of voltages used by the nonvolatile memory 301 may be changed according to the type and design of the nonvolatile memory 301.

The nonvolatile memory 301 stores repair information corresponding to the banks BK0 to BK3, that is, repair addresses, The nonvolatile memory 301 may include one of an e-fuse array circuit, a NAND flash memory, a NOR flash memory, an EPROM, an EEPROM, a FRAM, and a MRAM. The nonvolatile memory 301 operates using the voltages VDD, VSS, VPP, VBB, and VDIV. The nonvolatile memory 301 initiates to transmit the stored repair information to the registers 310_0 to 310_3 in response to the activation of a boot-up signal BOOTEN. That is, the nonvolatile memory 301 starts a boot-up operation in response to the activation of the boot-up signal BOOTEN.

The plurality of registers 310_0 to 310_3 store repair information of the memory banks BK0 to BK3 corresponding to the registers 310_0 to 310_3. The repair information is transferred from the nonvolatile memory 301 to the registers 310_0 to 310_3 and stored therein in the boot-up operation. Each of the registers 310_0 to 310_3 includes a latch circuit and substantially maintains the stored information only while power is being supplied.

Each of the memory banks BK0 to BK3 is configured to perform a repair operation for replacing a failed cell with a redundancy cell using the repair information stored in the registers 310_0 to 310_3. The memory bank BK0 use the repair information stored in the register 310_0 and the memory bank BK2 use the repair Information stored in the register 310_2.

The boot-up control circuit 320 is configured to activate the boot-up signal BOOTEN at the time of stabilization of the voltages VDD, VPP, VBB, and VDIV used in the nonvolatile memory 301. The nonvolatile memory 301 may start the boot-up operation quickly as soon as possible after the memory device is turned on. This is because it may be possible for he memory device to perform a normal operation only when the boot-up operation is completed. order for the memory device to normally operate, the levels of at least the voltages VDD, VPP, VBB, and VDIV used in the nonvolatile memory 301 need to be stabilized. This is because when the voltages VDD, VPP, VBB, and VDIV are not stabilized, a stable boot-up operation of the nonvolatile memory 301 may be not possible. The boot-up control circuit 320 detects the stabilization time points of the levels of the voltages VDD, VPP, VBB, and VDIV used in the nonvolatile memory 301, and controls the boot-up operation of the nonvolatile memory 301 to be started after the stabilization time points, thereby allowing the boot-up operation to be performed at the most early time at which a stable boot-up operation is achieved. Furthermore, since a boot-up signal is internally generated without using a control signal input from an exterior of the memory device, a separate control signal is not required.

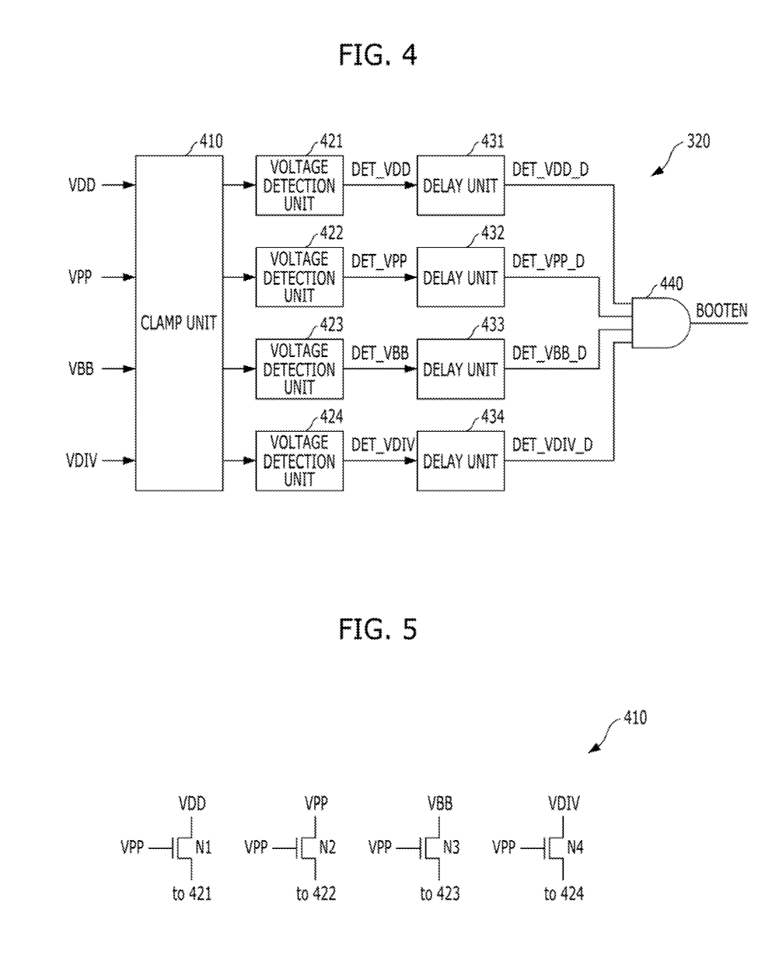

FIG. 4 is a diagram of the boot-up control circuit shown in FIG. 3 in accordance with an embodiment.

With reference to FIG. 4, an embodiment, in which the levels of the voltages VDD, VPP, VBB, and VDIV used in the nonvolatile memory 301 are detected and the boot-up signal BOOTEN is generated, will be described. Since the ground voltage VSS is a voltage serving as a reference of 0 V and needs not to be stabilization, the boot-up control circuit 320 does not detect the level of the ground voltag VSS.

Referring to FIG. 4, the boot-up control circuit 320 includes a damp unit 410, voltage detection units 421 to 424, delay units 431 to 434, and a signal generation unit 440.

The clamp unit 410 transfers the voltages VDD, VPP, VBB, and VDIV, which have been input to the boot-up control circuit 320, to the voltage detection units 421 to 424. In detail, the clamp unit 410 transfers the voltages VDD, VPP, VBB, and VDIV to the voltage detection units 421 to 424 in response to a level of one of the voltages VDD, VPP, VBB, and VDIV. Furthermore, the one voltage may be a voltage, at which stabilization is lastly achieved, among the voltages VDD, VPP, VBB, and VDIV. The configuration of the clamp unit 410 will be described in more detail with reference to FIG. 5. The clamp unit 410 allows the voltage detection units 421 to 424 to start to operate after the voltage lastly stabilized among the voltages VDD, VPP, VBB, and VDIV has a predetermined level or more.

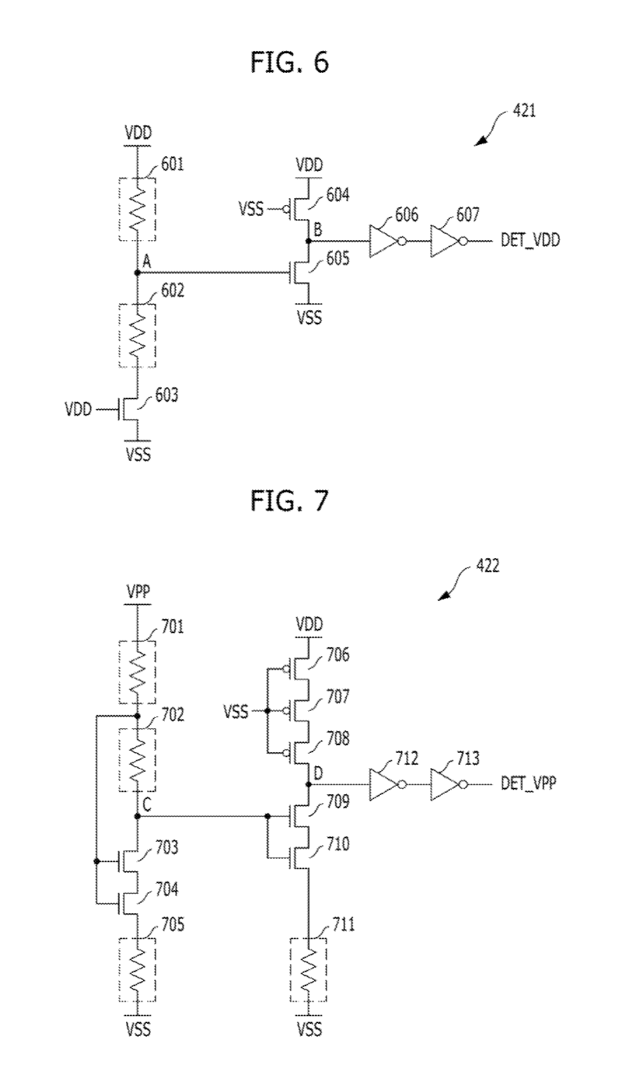

The voltage detection units 421 to 424 generate a plurality of detection signals DET_VDD, DET_VPP, DET_VBB, and DET_VDIV which is activated when the levels of the voltages received from the clamp unit 410 reaches a target voltage. The target voltage may be set to be slightly lower than the levels of the voltages VDD, VPP, VBB, and VDIV in a steady state. For example, in the case in which the voltage level of the high voltage VPP in a stead state is 4 V, when the level of the high voltage VPP reaches 3.5 V, the voltage detection unit 422 may activate the detection signal DET_VPP. Furthermore, in the case in which the voltage level of the negative voltage VBB in a stead state is 2 V when the level of the negative voltage VBB reaches −1.8 V, the voltage detection unit 423 may activate the detection signal DET_VBB. The configuration of the voltage detection units 421 to 424 will be described in more detail with reference to FIG. 6 to FIG. 8.

The delay units 431 to 434 delay the detection signals DET_VDD, DET_VPP, DET_VBB, and DET_VDIV and to transfer delayed detection signals DET_VDD_D, DET_VPP_D, DET_VBB_D, and DET_VDIV_D to the signal generation unit 440. The delay units 431 to 434 are provided in order to provide a predetermined stabilization time after the detection signals DET_VDD, DET_VPP, DET_VBB, and DET_VDIV are stabilized.

The signal generation unit 440 is configured to activate the boot-up signal BOOTEN when all the detection signals DET_VDD_D, DET_VPP_D, DET_VBB_D, and DET_VDIV_D delayed by the delay units 431 to 434 are activated. Since the activation of the delayed detection signals DET_VDD_D, DET_VPP_D, DET_VBB_D, and DET_VDIV_D represents that the levels of all the voltages VDD, VPP, VBB, and VDIV have been stabilized, a stable boot-up operation of the nonvolatile memory 301 is possible from this time point. As described in FIG. 4, the signal generation unit 440 may include an AND gate configured to receive the delayed detection signals DET_VDD_D, DET_VPP_D, DET_VBB_D and output the boot-up signal BOOTEN.

The clamp unit 410 and the delay units 431 to 434 are provided in order to ensure a time margin in a process of checking the stabilization of the voltages VDD, VPP, VBB, and VDIV. Accordingly, the clamp unit 410 and the delay units 431 to 434 may be omitted from the boot-up control circuit 320. That is, the voltages VDD, VPP, VBB, and VDIV may be directly input to the voltage detection units 421 to 424 without passing through the clamp unit 410, and the detection signals DET_VDD, DET_VPP, DET_VBB, and DET_VDIV may be directly input to the signal generation unit 440 without passing through the delay units 431 to 434.

FIG. 5 is a diagram of the clamp nit shown in FIG. 4 in accordance with an embodiment.

As illustrated in FIG. 5, the clamp unit 410 may include NMOS transistors N1 to N4 configured to transfer the voltages VDD, VPP, VBB, and VDIV to the voltage detection units 421 to 424 in response to the high voltage VPP. Since the high voltage VPP is highly likely to be stabilized later than the other voltages the NMOS transistors N1 to N4 are configured to transfer the voltages VDD, VPP VBB, and VDIV in response to the high voltage VPP. As a consequence, the NMOS transistors N1 to N4 are turned on after the high voltage VPP reaches a predetermined level or more, and transfer the voltages VDD, VPP, VBB, and VDIV to the voltage detection units 421 to 424.

Differently from FIG. 5, the clamp unit 410 may include PMOS transistors configured to transfer the voltages to the voltage detection units 421 to 424 in response to the negative voltage VBB. This is because the negative voltage VBB is highly likely to be stabilized later than the other voltages, similarly to the high voltage VPP.

FIG. 6 is a diagram of the voltage detection unit shown FIG. 4 in accordance with an embodiment.

Referring to FIG. 6, the voltage detection unit 421 includes NMOS transistors 603 and 605, a PMOS transistor 604, resistors 601 and 602, and inverters 606 and 607. The voltage detection unit 421 is a circuit for detecting the level of the power supply voltage VDD using the power supply voltage VDD, and such a circuit has been well-known as a power-up circuit.

The operation of the voltage detection unit 421 will be described below. When the level of the power supply voltage VDD is low, the NMOS transistor 603 is turned off and a voltage level of a node A is increased, so that the NMOS transistor 605 is turned on. As a consequence, a voltage level of a node B is reduced, so that the detection signal DET_VDD is deactivated to a ‘low’ level. However, when the level of the power supply voltage VDD is increased more than a predetermined level, the NMOS transistor 603 is turned on and the voltage level of the node A is reduced, so that the NMOS transistor 605 is turned off. As a consequence, the voltage level of the node B is increased, so that the detection signal DET_VDD is activated to a ‘high’ level.

FIG. 7 is a diagram of the voltage detection unit shown in FIG. 4 in accordance with an embodiment.

Referring to FIG. 7, the voltage detection unit 422 includes resistors 701, 702, 705, and 711 NMOS transistors 703, 704, 709, and 710, PMOS transistors 706, 707, and 708, and inverters 712 and 713.

When the level of the high voltage VPP is low, the NMOS transistors 703 and 704 are turned off and a voltage level of a node C is increased, so that the NMOS transistors 709 and 710 are turned on. As a consequence, a voltage level of a node D is reduced, so that the detection signal DET_VPP is deactivated to a ‘low’ level. However, when the level of the high voltage VPP is sufficiently high, the NMOS transistors 703 and 704 are turned on and the voltage level of the node C is reduced, so that the NMOS transistors 709 and 710 are turned off. As a consequence, the voltage level of the node D is increased, so that the detection signal DET_VPP is activated to a ‘high’ level.

The voltage detection unit 424 may have a configuration substantially equal to that of the voltage detection unit shown in FIG. 6 or FIG. 7. Furthermore, it may be sufficient if parameters of transistors and resistors are designed to be changed according to the level of the division voltage VDIV detected by the voltage detection unit 424.

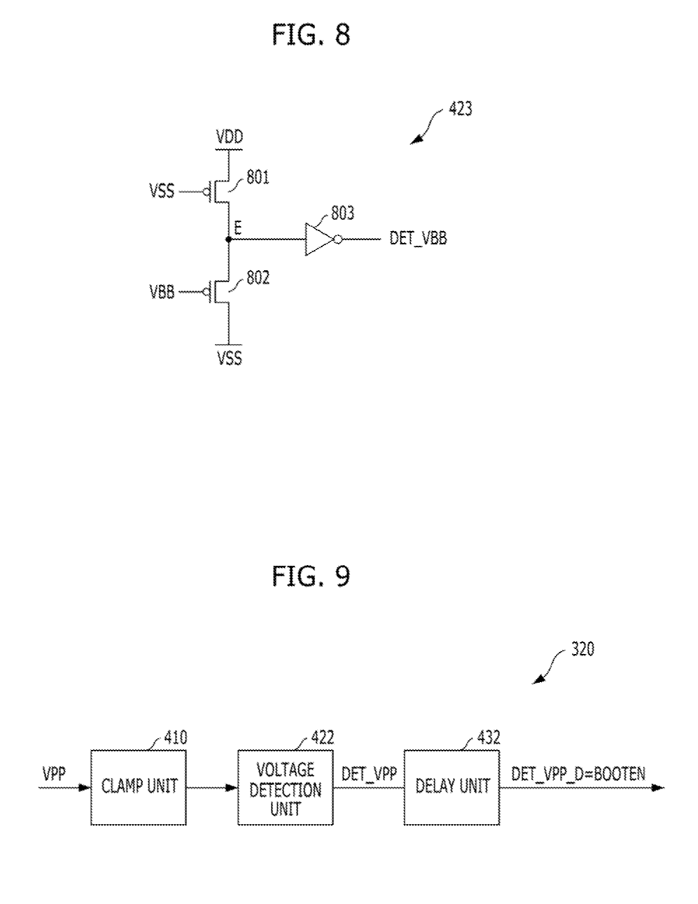

FIG. 8 is a diagram of the voltage detection unit shown in FIG. 4 in accordance with an embodiment.

Referring to FIG. 8, the voltage detection unit 423 includes PMOS transistors 801 and 802 and an inverter 803.

When an absolute value of the negative voltage VBB is small (that is, when the level of the negative voltage is high), a resistance value of the PMOS transistor 802 is increased and a voltage level of a node E is increased, so that the detection signal DET_VBB is output at a low level. When the absolute value of the negative voltage VBB is large (that is, when the level of the negative voltage is low), the resistance value of the PMOS transistor 802 is reduced and the voltage level of the node E is reduced, so that the detection signal DET_VBB is output at a ‘high’ level.

FIGS. 6 to 8 illustrate the voltage detection units 421 to 424. However, in addition to the circuits illustrated in FIGS. 6 to 8, various types of circuits for detecting the levels of voltages may be used as the voltage detection units 421 to 424.

FIG. 9 is a diagram of the boot-up control circuit shown in FIG. 3 in accordance with another embodiment.

With reference to FIG. 9, an embodiment, in which the level of only one voltage VPP of the voltages VDD, VPP, VBB, and VDIV used in a nonvolatile memory is detected and a boot-up signal BOOTEN is generated, will be described. When the voltage VPP highly likely to be lastly stabilized among the voltages VDD, VPP, VBB, and VDIV has been stabilized, since it is possible to assume that the other voltages VDD, VBB, and VDIV have been stabilized, the embodiment of FIG. 9 is possible.

Referring to FIG. 9, the boot-up control circuit 320 includes a clamp unit 410, a voltage detection unit 422, and a delay unit 432. The clamp unit 410 may be designed to include only the NMOS transistor N2 of FIG. 5 and the voltage detection unit 422 may be designed to have a configuration substantially equal to that of FIG. 7. In the embodiment of FIG. 9, since only one detection signal DET_VPP is generated and the detection signal DET_VPP serves as the boot-up signal BOOTEN, the boot-up control circuit 320 does not include the signal generation unit 440 as illustrated in FIG. 4.

Similarly to the embodiment of FIG. 4, in the embodiment of FIG. 9, the clamp unit 410 and the delay unit 432 may be omitted.

In the embodiment of FIG. 9, the level of the high voltage VPP is detected among the voltages VDD, VPP, VBB, and VDIV and the boot-up signal BOOTEN is generated. However it is possible to employ another embodiment its which the level of the negative voltage VBB may be detected among the voltages VDD, VPP, VBB, and VDIV and the boot-up signal BOOTEN may be generated. This is because the negative voltage VBB also corresponds to a voltage which is late stabilized among the voltages VDD, VPP, VBB, and VDIV. Furthermore, in the embodiment described with reference to FIG. 4, the levels of the four voltages VDD, VPP, VBB, and VDIV are detected and the boot-up signal BOOTEN is generated, and in the embodiment of FIG. 9, the level of one voltage VPP is detected and the boot-up signal BOOTEN is generated. However, the levels of two or three voltages may be detected and the boot-up signal BOOTEN may be generated.

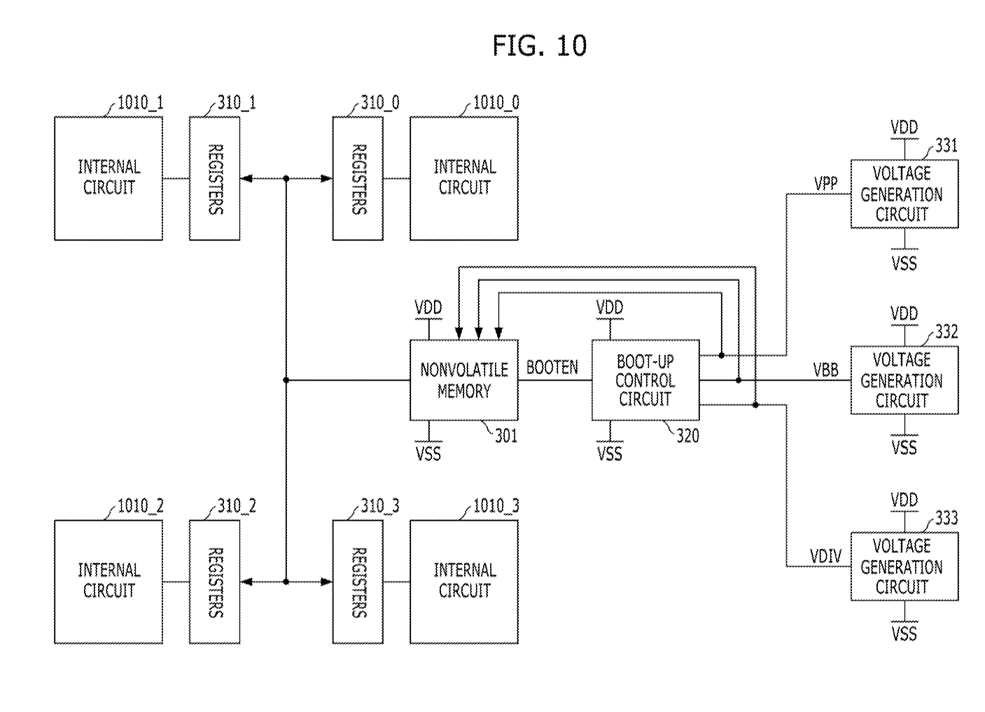

FIG. 10 is a diagram of an integrated circuit in accordance with an embodiment of the present invention.

As illustrated in FIG. 10, the present invention can be applied to all kinds of integrated circuits as well as a memory device. Referring to FIG. 10, the integrated circuit includes a nonvolatile memory 301, a plurality of registers 310_0 to 310_3, a plurality of internal circuits 1010_0 to 1010_3, a boot-up control circuit 320, and voltage generation circuits 331 to 333.

The nonvolatile memory 301 is configured to operate using a plurality of voltages VDD, VSS, VPP, VBB, and VDIV and output stored data in response to a boot-up signal BOOTEN. The nonvolatile memory 301 is configured to store information, for example, various types of setting or tuning information required for the operations of the plurality of internal circuits 1010_0 to 1010_3 and to transfer the stored information to the registers 310_0 to 310_3 in a boot-up operation.

The internal circuits 1010_0 to 1010_3 are circuits configured to operate using the information transferred from the nonvolatile memory 301 to the registers 310_0 to 310_3 among circuits in the integrated circuit. When the internal circuit 1010_0 is a voltage generation circuit, the internal circuit 1010_0 may adjust the level of a voltage, which is generated by the internal circuit 1010_0 using the information stored in the register 310_0. Furthermore, when the internal circuit 1010_1 is a delay circuit, the internal circuit 1010_1 may adjust a delay value of the internal circuit 1010_1 using the information stored in the register 310_1. Furthermore, when the internal circuit 1010_2 is a circuit for setting an operation mode of the integrated circuit, the internal circuit 1010_2 may set the operation mode of the integrated circuit using all types of information stored in the register 310_2. As described above, the internal circuits 1010_0 to 1010_3 may be all circuits, which operate using information stored in the nonvolatile memory 301, in the integrated circuit.

In this embodiment, since the present invention is applied to a general integrated circuit other than a memory device and content related to the determination of a boot-up time point is substantially equal to those described in reference to FIG. 3 to FIG. 9, detailed description thereof will be omitted herein.

While the present invention has been described with respect to the specific embodiments, it will be apparent to those skilled in the art that various changes and modifications may be made without departing from the spirit and scope of the invention as defined in the following claims.

What is claimed is:

1. A memory device comprising:
a nonvolatile memory, operated by using a plurality of voltages, and configured to output stored repair information in response to a boot-up signal;
a plurality of registers configured to store the repair information output from the nonvolatile memory;
a plurality of memory banks configured to replace a normal cell with a redundancy cell using the repair information stored in registers corresponding to the plurality of memory banks among the plurality of registers; and
a boot-up control circuit configured to activate the boo up signal at a time of stabilization of the plurality of voltages.

2. The memory device of claim, wherein the boot-up control circuit comprises:
a plurality of voltage detection units configured to detect voltage levels of the plurality of voltages, and to generate a plurality of detection signals which are activated when the voltage levels of the plurality of voltages reach respective target voltages; and
a signal generation unit configured to activate the boot-up signal when all the plurality of detection signals are activated.

3. The memory device of claim 1, wherein the boot-up control circuit comprises:
a plurality of voltage detection units configured to detect voltage levels of the plurality of voltages, and to generate a plurality of detection signals which are activated when the voltage levels of the plurality of voltages reach respective target voltages;
a plurality of delay units configured to delay the plurality of detection signals and generate a plurality of delayed detection signals; and
a signal generation unit configured to activate the boot-up signal when all the plurality of delayed detection signals are activated.

4. The memory device of claim, wherein the boo up control circuit comprises:
a clamp unit configured to transfer the plurality of voltages in response to a level of one of the plurality of voltages;
a plurality of voltage detection units configured to generate a plurality of detection signals which are activated when voltage levels of the plurality of voltages received from the clamp unit reach respective target voltages;
a plurality of delay units configured to delay the plurality of detection signals; and
a signal generation unit configured to activate the boot-up signal when all the plurality of detection signals delayed by the plurality of delay units are activated.

5. The memory device of claim 4, wherein the one voltage is a voltage which is lastly stabilized among the plurality of voltages.

6. The memory device of claim 1, wherein the boot-up control circuit comprises:
a voltage detection unit configured to detect a level of one of the plurality of voltages, and to generate the boot-up signal which is activated when the one voltage reaches a target voltage.

7. The memory device of claim 1, wherein the boot-up control circuit comprises:
a voltage detection unit configured to detect a level of one of the plurality of voltages, and to generate a detection signal which is activated when the one voltage reaches a target voltage; and
a delay unit configured to delay the detection signal and generate the boot-up signal.

8. The memory device of claim wherein the boot-up control circuit comprises:
a clamp unit configured to transfer one voltage of the plurality of voltages in response to the one voltage;
a voltage detection unit configured to generate a detection signal which is activated when a voltage level of the voltage received through the clamp unit reaches a target voltage; and
a delay unit configured to delay the detection signal and generate the boot-up signal.

9. The memory device of claim 6, wherein the one voltage is a voltage which is lastly stabilized among the plurality of voltages.

10. The memory device of claim 7, wherein the one voltage is a voltage which is lastly stabilized among the plurality of voltages.

11. The memory device of claim 8, wherein the one voltage is a voltage which is lastly stabilized among the plurality of voltages.

12. The memory device of claim 1, wherein the plurality of voltages include a power supply voltage applied from an exterior of the memory device, a division voltage generated by dividing the power supply voltage, a high voltage generated by pumping the power supply voltage, and a negative voltage generated by pumping a ground voltage.

13. The memory device of claim 1, wherein the nonvolatile memory includes one of an e-fuse array circuit, a NAND flash memory, a NOR flash memory, an EPROM, an EEPROM, a FRAM, and a MRAM.

14. An integrated circuit comprising:
a nonvolatile memory, operated by using a plurality of voltages and configured to output stored data in response to a boot-up signal;
a plurality of registers configured to store the data output from the nonvolatile memory;
a plurality of internal circuits configured to operate using the data stored in registers corresponding to the plurality of internal circuits among the plurality of registers; and
a boot-up control circuit configured to activate the boot-up signal at a time of stabilization of the plurality of voltages.

15. The integrated circuit of claim 14, wherein the boot-up control circuit comprises:
a plurality of voltage detection units configured to detect voltage levels of the plurality of voltages, and to generate a plurality of detection signals which are activated when the voltage levels of the plurality of voltages reach respective target voltages; and
a signal generation unit configured to activate the boot-up signal when all the plurality of detection signals are activated.

16. The integrated circuit of claim 14, wherein the boot-up control circuit comprises:
a plurality of voltage detection units configured to detect voltage levels of the plurality of voltages, and to generate a plurality of detection signals which are activated when the voltage levels of the plurality of voltages reach respective target voltages;
a plurality of delay units configured to delay the plurality of detection signals and generate a plurality of delayed detection signals; and
a signal generation unit configured to activate the boot-up signal when all the plurality of delayed detection signals are activated.

17. The integrated circuit of claim 14, wherein the boot-up control circuit comprises:
a clamp unit configured to transfer the plurality of voltages in response to a level of one of the plurality of voltages;
a plurality of voltage detection units configured to detect voltage levels of the plurality of voltages, and to generate a plurality of detection signals which are activated when the voltage levels of the plurality of voltages reach respective target voltages;
a plurality of delay units configured to delay the plurality of detection signals and generate a plurality of delayed detection signals; and
a signal generation unit configured to activate the boot-up signal when all the plurality of delayed detection signals are activated.

18. The integrated circuit of clam 14, wherein the boot-up control circuit comprises:
a voltage detection unit configured to detect a level of one of the plurality of voltages and to generate the boot-up signal which is activated when the one voltage reaches a target voltage.

19. The integrated circuit of claim 14, wherein the boot-up control circuit comprises:
a voltage detection unit configured to detect a level of one of the plurality of voltages, and to generate a detection signal which is activated when the one voltage reaches a target voltage; and
a delay unit configured to delay the detection signal and generate the boot-up signal.

20. The integrated circuit of claim 14, wherein the boot-up control circuit comprises:
a clamp unit configured to transfer one voltage of the plurality of voltages in response to the one voltage;
a voltage detection unit configured to generate a detection signal which is activated when a voltage level of the voltage received through the clamp unit reaches a target voltage; and
a delay unit configured to delay the detection signal and generate the boot-up signal.
